(19) United States
(12) Patent Application Publication
(10) Pub. No.: US 2022/0297245 A1
(43) Pub. Date: Sep. 22, 2022

(54) A METHOD FOR THE MANUFACTURE OF AN ASSEMBLY BY LASER WELDING

(71) Applicant: ArcelorMittal, Luxembourg (LU)

(72) Inventors: Marcos PEREZ RODRIGUEZ, Cangas Del Narcea Asturias (ES); Alvaro MANJON FERNANDEZ, Oviedo Asturias (ES); Virgilio GARCIA ORGEIRA, Oviedo Asturias (ES); Sivasambu BOHM, Godmanchester Cambridgeshire (GB)

(21) Appl. No.: 17/603,681

(22) PCT Filed: Apr. 16, 2020
(86) PCT No.: PCT/IB2020/053588

§ 371 Date: Oct. 14, 2021

(30) Foreign Application Priority Data
Apr. 17, 2019 (IB) PCT/IB2019/053178

(51) Int. Cl. B23K 35/365; B23K 26/21; B05D 7/14; B05D 3/02

(52) U.S. Cl. CPC B23K 35/365; B23K 26/21; B05D 7/14; B05D 3/0254; B23K 2103/04

(57) ABSTRACT

A pre-coated steel substrate coated with optionally, an anticorrosion coating and a pre-coating including at least one titanate and at least one nanoparticle, the steel substrate having a reflectance higher or equal to 60% at wavelengths between 6.0 and 15.0 μm.

The present invention relates to a pre-coated steel substrate wherein the coating comprises at least one titanate and at least one nanoparticle, said steel substrate having a reflectance higher or equal to 60% at all wavelengths between 6.0 and 15.0 μm; a method for the manufacture of an assembly; a method for the manufacture of a coated metallic substrate and finally a coated metallic substrate. It is particularly well suited for construction and automotive industries.

### BACKGROUND

It is known to use steel parts to produce vehicles. Usually, the steel parts can be made of high strength steel sheets to achieve lighter weight vehicle bodies and improve crash safety. The manufacture of steel parts is generally followed by the welding of the steel part with another metallic substrate. Such welding can be difficult to realize since there is not a deep weld penetration in steel substrates.

### SUMMARY OF THE INVENTION

Sometimes, steel parts are welded by Laser Beam welding which is a common welding process. Laser beam welding (LBW) is a welding technique used to join pieces of metal through the use of a laser. The beam provides a concentrated heat source, allowing for narrow, deep welds and high welding rates. The process is frequently used in high volume applications using automation, such as in the automotive industry. It is based on keyhole or penetration mode welding. LBW is a process, capable of welding carbon steels, HSLA steels, stainless steel, aluminum, and titanium. Due to high cooling rates, cracking is a concern when welding high-carbon steels. The speed of welding is proportional to the amount of power supplied but also depends on the type and thickness of the workpieces. The high-power capability of gas lasers makes them especially suitable for high volume applications. LBW is particularly dominant in the automotive industry.

Nevertheless, especially for carbon steels, there is a need to improve the welding penetration and to reduce the risk of cracks of carbon steels.

Thus, there is a need to improve the weld penetration in steel substrates and therefore the mechanical properties of a welded steel substrates. There is also a need to obtain an assembly of at least two metallic substrates welded together by Laser welding, said assembly comprising a steel substrate.

The present invention provides a pre-coated steel substrate coated with:
optionally, an anticorrosion coating and
a pre-coating comprising at least one titanate and at least one nanoparticle,
said bare steel substrate having a reflectance higher or equal to 60% at all wavelengths between 6.0 and 15.0 μm.

The pre-coated steel substrate according to the invention may also have the optional features listed below, considered individually or in combination:
the pre-coating comprises at least titanate chosen from among: Na₂Ti₃O₇, K₂TiO₃, K₂Ti₂O₅ MgTiO₃, SrTiO₃, BaTiO₃, and CaTiO₃, FeTiO₃ and ZnTiO₄ or a mixture thereof,
the pre-coating comprises at least nanoparticles chosen from TiO₂, SiO₂, Yttria-stabilized zirconia (YSZ), Al₂O₃, MoO₃, CrO₃, CeO₂ or a mixture thereof,
the pre-coating further comprises an organic solvent,
the thickness of the coating is between 10 to 140 μm,
the percentage of nanoparticle(s) is below or equal to 80 wt. %,
the percentage of titanate(s) is above or equal to 45 wt. %,
the bare steel substrate has a reflectance higher or equal to 70% at all wavelengths between 6.0 and 15.0 μm,
the anti-corrosion coating includes a metal selected from among the group comprising zinc, aluminum, copper, silicon, iron, magnesium, titanium, nickel, chromium, manganese and their alloys.
the diameter of the at least one titanate is between 1 and 40 μm.

The invention also relates to a method for the manufacture of the pre-coated metallic substrate according to the invention, comprising the successive following steps:
A. The provision of a steel substrate according to the invention,
B. The deposition of the pre-coating according to the invention,
C. Optionally, the drying of the coated metallic substrate obtained in step B).

The method according to the invention may also have the optional features listed below, considered individually or in combination:
in step B), the deposition of the pre-coating is performed by spin coating, spray coating, dip coating or brush coating,
in step B), the pre-coating comprises from 1 to 200 g/L of nanoparticle(s),
in step B), the pre-coating comprises from 100 to 500 g/L of titanate.

The invention also relates to a method for the manufacture of an assembly comprising the following successive steps:
I. The provision of at least two metallic substrates wherein at least one metallic substrate is the pre-coated steel substrate according to the invention and
II. The welding of at least two metallic substrates by Laser welding, the Laser welding machine having a laser having wavelengths between 6.0 and 15.0 μm.

The method according to the invention may also have the optional features listed below, considered individually or in combination:
in step II), the laser welding is performed with a shielding gas being an inert gas and/or an active gas,
in step II), the power of the laser is between 1 and 20 kW.

The invention also relates to an assembly of at least two metallic substrates at least partially welded together through Laser welding obtainable from the method according to the invention, said assembly comprising:
at least one bare steel substrate coated with optionally an anticorrosion coating,
a welded zone comprising the dissolved and/or precipitated pre-coating comprising at least one titanate and at least one nanoparticle and
said bare steel substrate having a reflectance higher or equal to 60% at wavelengths between 6.0 and 15.0 μm.

The assembly according to the invention may also have the optional features listed below, considered individually or in combination:
the second metallic substrate is a steel substrate or an aluminum substrate,
the second metallic substrate is a pre-coated steel substrate according to the invention,
the at least two metallic substrates comprise dissolved and/or precipitated titanate and nanoparticles.

Finally, the invention relates to the use of an assembly obtainable from the method according to the invention for the manufacture of automotive or shipbuilding parts.

### DETAILED DESCRIPTION

The following terms are defined:
Nanoparticles are particles between 1 and 100 nanometers (nm) in size.
Titanate refers to inorganic compounds whose composition combines a titanium oxide with at least one other oxide. They can be in the form of their salts.
“coated” means that the steel substrate is at least locally covered with the pre-coating. The covering can be for example limited to the area where the steel substrate will be welded. “coated” inclusively includes “directly on” (no intermediate materials, elements or space disposed therebetween) and “indirectly on” (intermediate materials, elements or space disposed therebetween). For example, coating the steel substrate can include applying the pre-coating directly on the substrate with no intermediate materials/elements therebetween, as well as applying the pre-coating indirectly on the substrate with one or more intermediate materials/elements therebetween (such as an anticorrosion coating).
Reflectance of the surface of a material is its effectiveness in reflecting radiant energy. It is the fraction of incident electromagnetic power that is reflected at an interface. The reflectance can be measured by spectroscopy.

Without willing to be bound by any theory, it is believed that the pre-coating mainly modifies the melt pool physics of the steel substrate allowing a deeper melt penetration. It seems that, in the present invention, not only the nature of the compounds, but also the size of the particles being equal or below 100 nm improve the penetration thanks to the keyhole effect, the Marangoni effect and an increase of absorbance.

Indeed, the titanate mixed with nanoparticles enhances the keyhole effect weld which causes a deep penetration. The keyhole refers to a literal hole in the steel substrate, caused by its vaporization, which allows the energy beam to penetrate even more deeply. Energy is delivered very efficiently into the joint, which maximizes weld depth and minimizes the heat affected zone, which in turn limits part distortion.

Moreover, the pre-coating improves the Marangoni flow, which is the mass transfer at the liquid-gas interface due to the surface tension gradient. In particular, the components of the pre-coating modify the gradient of surface tension along the interface. This modification of surface tension results in an inversion of the fluid flows towards the center of the weld pool which in this case results in improvements in the weld penetration and in the wettability.

Without willing to be bound by any theory, it is believed that the nanoparticles dissolve at lower temperature than microparticles and therefore more oxygen is dissolved in the melt pool, which activate the reverse Marangoni flow.

Additionally, it has been observed that the nanoparticles improve the homogeneity of the applied pre-coating by filling the gaps between the microparticles. It helps improving the weld penetration and quality.

Finally, it seems that the chosen nanoparticles increase the absorbance of steel substrate leading to higher penetration. Consequently, steel substrates can be welded even if the reflectance of their bare surface is higher or equal to 60% at all wavelengths between 6.0 and 15.0 μm.

Preferably, the pre-coating comprises at least one nanoparticle chosen from TiO₂, SiO₂, Yttria-stabilized zirconia (YSZ), Al₂O₃, MoO₃, CrO₃, CeO₂ or a mixture thereof. Indeed, without willing to be bound by any theory, it is believed that these nanoparticles further decrease the reflectance and modify the melt pool physics allowing a deeper weld penetration.

Preferably, the nanoparticles are SiO₂ and TiO₂, and more preferably a mixture of SiO₂ and TiO₂. Without willing to be bound by any theory, it is believed that SiO₂ mainly helps in increasing the penetration depth and the slag removal and detaching while TiO₂ mainly helps in increasing the penetration depth and alloying with steel to form Ti-based inclusions which improve the mechanical properties.

Preferably, the nanoparticles have a size comprised between 5 and 60 nm.

Preferably, the percentage in dry weight of the nanoparticles is below or equal to 80% and preferably between 2 and 40%. In some cases, the percentage of nanoparticles may have to be limited to avoid a too high refractory effect. The person skilled in the art who knows the refractory effect of each kind of nanoparticles will adapt the percentage case by case.

The nanoparticles are not selected among sulfides or halides which are detrimental for carbon steels.

Preferably, the titanate has a particle size distribution between 1 and 40 μm, more preferably between 1 and 20 μm and advantageously between 1 and 10 μm. Indeed, without willing to be bound by any theory, it is believed that this titanate diameter further improves the keyhole effect and the Marangoni effect.

Preferably, the pre-coating comprises at least one kind of titanate chosen from among: Na₂Ti₃O₇, NaTiO₃, K₂TiO₃, K₂Ti₂O₅ MgTiO₃, SrTiO₃, BaTiO₃, CaTiO₃, FeTiO₃ and ZnTiO₄ or a mixture thereof. Indeed, without willing to be bound by any theory, it is believed that these titanates further increase the deposition of the metallic coating and increase the coating penetration depth based on the effect of the reverse Marangoni flow.

Preferably, the percentage in dry weight of the at least one titanate is above or equal to 45% and for example of 50 or of 70%.

According to one variant of the invention, once the pre-coating is applied on the steel substrate and dried, it consists of at least one titanate and at least one nanoparticle.

According to another variant of the invention, the coating further comprises at least one binder embedding the titanate and the nanoparticles and improving the adhesion of the pre-coating on the steel substrate. Preferably, the binder is purely inorganic, notably to avoid fumes that an organic binder could possibly generate during welding. Examples of inorganic binders are sol-gels of organofunctional silanes or siloxanes. Examples of organofunctional silanes are silanes functionalized with groups notably of the families of amines, diamines, alkyls, amino-alkyls, aryls, epoxys, methacryls, fluoroalkyls, alkoxys, vinyls, mercaptos and aryls. Amino-alkyl silanes are particularly preferred as they are greatly promoting the adhesion and have a long shelf life. Preferably, the binder is added in an amount of 1 to 20 wt % of the dried pre-coating.

Preferably the thickness of the coating is between 10 to 140 μm, more preferably between 30 to 100 μm.

Preferably, the steel substrate is carbon steel.

According to the present invention, the bare metallic substrate has a reflectance higher or equal to 60%, more preferably above or equal to 70%, at all wavelengths between 6.0 and 15.0 μm, preferably between 8.0 and 13.0 μm and for Example between 9.0 and 11.0 μm. Indeed, without willing to be bound by any theory, it is believed that the reflectance of the metallic substrate depends on the wavelengths of the laser source.

With the pre-coating according to the present invention, it is believed that the metallic substrate reflectance is reduced below 30%, preferably below 20%, at all wavelengths between 6.0 and 15.0 μm.

Preferably, the anti-corrosion coating includes a metal selected from the group consisting of zinc, aluminum, copper, silicon, iron, magnesium, titanium, nickel, chromium, manganese and their alloys.

In a preferred embodiment, the anti-corrosion coating is an aluminum-based coating comprising less than 15% Si, less than 5.0% Fe, optionally 0.1 to 8.0% Mg and optionally 0.1 to 30.0% Zn, the remainder being Al. In another preferred embodiment, the anti-corrosion coating is a zinc-based coating comprising 0.01-8.0% Al, optionally 0.2-8.0% Mg, the remainder being Zn.

The anti-corrosion coating is preferably applied on at least one side of the steel substrate.

The invention also relates to a method for the manufacture of the pre-coated metallic substrate, comprising the successive following steps:
A. The provision of a steel substrate according to the present invention,
B. The deposition of the pre-coating according to the present invention,
C. Optionally, the drying of the coated metallic substrate obtained in step B).

Preferably, in step A), the steel substrate is carbon steel.

Preferably, in step B), the deposition of the pre-coating is performed by spin coating, spray coating, dip coating or brush coating.

Preferably, in step B), the pre-coating is deposited locally only. In particular, the pre-coating is applied in the area where the steel substrate will be welded. It can be on the edge of the steel substrate to be welded or on one part of one side of the substrate to be welded. More preferably, the width of the applied pre-coating is at least as large as the weld to be done so that the absorbance is further improved.

Advantageously, the pre-coating further comprises an organic solvent. Indeed, without willing to be bound by any theory, it is believed that the organic solvent allows for a well dispersed pre-coating. Preferably, the organic solvent is volatile at ambient temperature. For example, the organic solvent is chosen from among: volatile organic solvents such as acetone, methanol, isopropanol ethanol, ethyl acetate, diethyl ether, non-volatile organic solvents such as ethylene glycol and water.

Advantageously, in step B), the pre-coating comprises from 1 to 200 g/L of nanoparticles, more preferably between 5 and 80 g·L⁻¹.

Preferably, in step B), the pre-coating comprises from 100 to 500 g/L of titanate, more preferably between 175 and 250 g·L⁻¹.

According to one variant of the invention, the pre-coating of step B) consists of at least one titanate, at least one nanoparticle and at least one organic solvent.

According to another variant of the invention, the pre-coating of step B) further comprises a binder precursor to embed the titanate and the nanoparticles and to improve the adhesion of the pre-coating on the steel substrate. Preferably, the binder precursor is a sol of at least one organofunctional silane. Examples of organofunctional silanes are silanes functionalized with groups notably of the families of amines, diamines, alkyls, amino-alkyls, aryls, epoxys, methacryls, fluoroalkyls, alkoxys, vinyls, mercaptos and aryls. Preferably, the binder precursor is added in an amount of 40 to 400 g·L−1 of the pre-coating.

When a drying step C) is performed, the drying is performed by blowing air or inert gases at ambient or hot temperature. When the pre-coating comprises a binder, the drying step C) is preferably also a curing step during which the binder is cured. The curing can be performed by Infra-Red (IR), Near Infra-Red (NIR), conventional oven.

Preferably, the drying step C) is not performed when the organic solvent is volatile at ambient temperature. Indeed, it is believed that after the deposition of the coating, the organic solvent evaporates leading to a dried pre-coating on the metallic substrate.

The invention also relates to a method for the manufacture of an assembly comprising the following successive steps:
I. The provision of at least two metallic substrates wherein at least one metallic substrate is the pre-coated steel substrate according to the present invention and
II. The welding of the at least two metallic substrates by Laser welding, the Laser welding machine having a laser having wavelengths between 6.0 and 15.0 μm.

Preferably, in step II), the laser deposition is performed with a shielding gas being an inert gas and/or active gas. For example, the inert gas is chosen from helium, neon, argon, krypton, xenon or a mixture thereof. For example, the active gas is chosen from among: CO₂, CO, and a mixture thereof. For example, the shield gas comprises 60-85 v. % of helium, 13-55 v. % of nitrogen and 1-9 v. % of carbon dioxide.

Preferably, in step II), the laser power is between 1 and 20 kW, more preferably between 1 and 10 kW.

According to the present invention, the laser source has wavelengths between 6.0 and 15.0 μm, preferably between 8.0 and 13.0 μm and for example between 9.0 and 11.0 μm.

With the method according to the present invention, it is possible to obtain an assembly of at least a first metallic substrate in the form of a steel substrate optionally coated with an anticorrosion coating and a second metallic substrate, the first and second metallic substrates being at least partially welded together through Laser welding wherein the welded zone comprises a dissolved and/or precipitated pre-coating comprising at least one titanate and at least one nanoparticle, said bare steel substrate having a reflectance higher or equal to 60% at wavelengths between 6.0 and 15.0 μm.

Preferably, the nanoparticle is chosen from among: TiO₂, SiO₂, Yttria-stabilized zirconia (YSZ), Al₂O₃, MoO₃, CrO₃, CeO₂ or a mixture thereof.

By “dissolved and/or precipitated pre-coating”, it is meant that components of the pre-coating can be dragged towards the center of the liquid-gas interface of the melt pool because of the reverse Marangoni flow and can be even dragged inside the molten metal. Some components dissolve in the melt pool which leads to an enrichment in the corresponding elements in the weld. Other components precipitate and are part of the complex oxides forming inclusions in the weld.

In particular, when the Al amount of the steel substrate is above 50 ppm, the welded zone comprises inclusions comprising notably Al—Ti oxides or Si—Al—Ti oxides or other oxides depending on the nature of the added nanoparticles. These inclusions of mixed elements are smaller than 5 μm. Consequently, they do not compromise the toughness of the welded zone. The inclusions can be observed by Electron Probe Micro-Analysis (EPMA). Without willing to be bound by any theory, it is believed that the nanoparticles promote the formation of inclusions of limited size so that the toughness of the welded zone is not compromised.

Preferably, the second metallic substrate is a steel substrate or an aluminum substrate. More preferably, the second steel substrate is a pre-coated steel substrate according to the present invention.

Finally, the invention relates to the use of an assembly according to the present invention for the manufacture of a part for automotive or shipbuilding.

### EXAMPLES

The following examples and tests are non-restricting in nature and must be considered for purposes of illustration only. They will illustrate the advantageous features of the present invention, the significance of the parameters chosen by the inventors after extensive experiments and further establish the properties that can be achieved by the invention.

For the Trials, the steel substrate having the chemical composition in weight percent disclosed in Table 1 was used:

| C | Mn | Si | Al | S | P | Cu | Ni | Cr |
|---|---|---|---|---|---|---|---|---|
| 0.102 | 0.903 | 0.012 | 0.04 | 0.0088 | 0.012 | 0.027 | 0.0222 | 0.027 |

| Nb | Mo | V | Ti | B | N | Fe |
|---|---|---|---|---|---|---|
| 0.0012 | 0.002 | 0.0011 | 0.0008 | 0.0001 | 0.0035 | Balance |

The steel substrate was 4 mm thick.

The reflectance of the steel substrates was of 90% at wavelength of 10.6 μm. These wavelengths are commonly used in laser sources of CO₂ Laser welding.

### Example 1

Trial 1 was not coated.

For Trial 2, an acetone solution comprising MgTiO₃ (diameter: 2 μm), SiO₂ (diameter: 10 nm) and TiO₂ (diameter: 50 nm) was prepared by mixing acetone with said elements. In the acetone solution, the concentration of MgTiO₃ was of 175 g·L⁻¹. The concentration of SiO₂ was of 25g·L⁻¹. The concentration of TiO₂ was of 50 g·L⁻¹. Then, Trial 2 was coated with the acetone solution by spraying. The acetone evaporated. The percentage of MgTiO₃ in the coating was of 70 wt. %, the percentage of SiO₂ was of 10 wt. % and the percentage of TiO₂ was of 20 wt. %. The coating thickness was of 40 μm.

Then, Trial 1 and 2 were joined with a steel substrate having the above composition by Laser welding. The welding parameters are in the following Table 2:

| Laser | | | Focal | Gas Flow | Laser |
|---|---|---|---|---|---|
| power | Speed | Voltage | length | He | wavelengths |
| (kW) | (m · min⁻¹) | (V) | (mm) | (L · min⁻¹) | (μm) |
| 4.5 | 1000 | 25 | 19 | 14 | 10.6 |

After the Laser welding, the steel microstructure was analyzed by Scanning Electron Microscopy (SEM). The composition of the welded area was analyzed by Energy-Dispersive X-ray Spectroscopy (EDS). The reflectance and the residual stress of the welded area was determined by simulations. Results are in the following Table 3:

| | Coating | Reflec- | Steel | | |
|---|---|---|---|---|---|
| | thick- | tance | micro- | Welding | Composition |
| | ness | (%) by | structure | penetration | of welded |
| Trials | (μm) | simulation | by SEM | by SEM | area by EDS |
| 1 | — | 90% | no formation of | Partial | Mn—Al |
| | | | brittle phases | penetration | inclusions |
| | | | (martensite + | (up to | |
| | | | ferrite) | 2.8 mm) | |
| 2* | 40 | <10% | no formation of | Full | Al—Mn—Ti |
| | | | brittle phases | penetration | Well |
| | | | (martensite + | (up to 4 mm) | dispersed |
| | | | ferrite) | | |

*according to the present invention

Results show that Trial 2 improves the Laser welding compared to comparative Trial 1.

### Example 2

For trial 3, a water solution comprising the following components was prepared: 363 g·L⁻¹ of MgTiO₃ (diameter: 2 μm), 77.8 g·L⁻¹ of SiO₂ (diameter range: 12-23 nm), 77.8 g·L⁻¹ of TiO₂ (diameter range: 36-55 nm) and 238 g·L⁻¹ of 3-aminopropyltriethoxysilane (Dynasylan® AMEO produced by Evonik®). The solution was applied on the steel substrate and dried by 1) IR and 2) NIR. The dried coating was 40 μm thick and contained 62 wt % of MgTiO₃, 13 wt % of SiO₂, 13 wt % of TiO₂ and 12 wt % of the binder obtained from 3-aminopropyltriethoxysilane.

For trial 4, a water solution comprising the following components was prepared: 330 g·L⁻¹ of MgTiO₃ (diameter: 2 μm), 70.8 g·L⁻¹ of SiO₂ (diameter range: 12-23 nm), 70.8 g·L⁻¹ of TiO₂ (diameter range: 36-55 nm), 216 g·L⁻¹ of 3-aminopropyltriethoxysilane (Dynasylan® AMEO produced by Evonik®) and 104.5 g·L⁻¹ of a composition of organofunctional silanes and functionalized nanoscale SiO₂ particles (Dynasylan® Sivo 110 produced by Evonik). The solution was applied on the steel substrate and dried by 1) IR and 2) NIR. The dried coating was 40 μm thick and contained 59.5 wt % of MgTiO₃, 13.46 wt % of SiO₂, 12.8 wt % of TiO₂ and 14.24 wt % of the binder obtained from 3-aminopropyltriethoxysilane and the organofunctional silanes.

In all cases, the adhesion of the pre-coating on the steel substrate was greatly improved.

What is claimed is:

1-25. (canceled)

26. A pre-coated steel substrate comprising:
a steel substrate; and
a pre-coating coating the steel substrate and including at least one titanate and at least one nanoparticle,
the steel substrate when bare having a reflectance higher or equal to 60% at all wavelengths between 6.0 and 15.0 μm.

27. The pre-coated steel substrate as recited in claim 26 wherein the at least one titanate is selected from the group consisting of: Na2Ti3O7, NaTiO3, K2TiO3, K2Ti2O5 MgTiO3, SrTiO3, BaTiO3, CaTiO3, FeTiO3, ZnTiO4 and mixtures thereof.

28. The pre-coated steel substrate as recited in claim 26 wherein the at least one nanoparticle is chosen from TiO2, SiO2, Yttria-stabilized zirconia (YSZ), Al2O3, MoO3, CrO3, CeO2 and mixtures thereof.

29. The pre-coated steel substrate as recited in claim 26 wherein a thickness of the pre-coating is between 10 to 140 μm.

30. The pre-coated steel substrate as recited in claim 26 wherein a percentage of the at least one nanoparticle is below or equal to 80 wt. %.

31. The pre-coated steel substrate as recited in claim 26 wherein a percentage of the at least one titanate is above or equal to 45 wt. %.

32. The pre-coated steel substrate as recited in claim 26 wherein the pre-coating further includes a binder.

33. The pre-coated steel substrate as recited in claim 32 wherein a percentage of the binder in the pre-coating is between 1 and 20 wt. %.

34. The pre-coated steel substrate as recited in claim 26 wherein the steel substrate when bare has a reflectance higher or equal to 70% at all wavelengths between 6.0 and 15.0 μm.

35. The pre-coated steel substrate as recited in claim 26 further comprising an anticorrosion coating.

36. The pre-coated steel substrate as recited in claim 35 wherein the anti-corrosion coating includes a metal selected from the group consisting of zinc, aluminum, copper, silicon, iron, magnesium, titanium, nickel, chromium, manganese and their alloys.

37. The pre-coated steel substrate as recited in claim 26 wherein a diameter of the at least one titanate is between 1 and 40 μm.

38. A method for manufacture of the pre-coated steel substrate as recited in claim 26, the method comprising the successive following steps:
A. providing the steel substrate; and
B. depositing the pre-coating.

39. The method as recited in claim 38 further comprising: C. drying the coated steel substrate obtained in step B.

40. The method as recited in claim 38 wherein in step B, the deposition of the pre-coating is performed by spin coating, spray coating, dip coating or brush coating.

41. The method as recited in claim 38 wherein, in step B, the pre-coating further includes an organic solvent.

42. The method as recited in claim 38 wherein in step B, the pre-coating includes from 1 to 200 g/L of at least one nanoparticle.

43. The method as recited in claim 38 wherein in step B, the pre-coating includes from 100 to 500 g/L of titanate.

44. The method as recited in claim 38 wherein, in step B, the pre-coating further includes a binder precursor.

45. A method for the manufacture of an assembly comprising the following successive steps:
providing at least two metallic substrates wherein a first of the at least two metallic substrates is a pre-coated steel substrate including a steel substrate coated with a pre-coating including at least one titanate and at least one nanoparticle, the steel substrate when bare having a reflectance higher or equal to 60% at all wavelengths between 6.0 and 15.0 μm and
welding of the at least two metallic substrates by laser welding at a wavelength between 6.0 and 15.0 μm.

46. The method as recited in claim 45 wherein the laser welding is performed by a laser welding machine having a laser having wavelengths between 6.0 and 15.0 μm.

47. The method as recited in claim 45 wherein the laser welding is performed with a shielding gas being an inert gas and/or an active gas.

48. The method as recited in claim 45 wherein a power of the laser is between 1 and 20 kW.

49. An assembly of at least a first metallic substrate in the form of the pre-coated steel substrate as recited in claim 26 and a second metallic substrate, the first and second metallic substrates being at least partially welded together through laser welding, the welded zone including the pre-coating as a dissolved or precipitated pre-coating.

50. The assembly as recited in claim 49 wherein the at least one nanoparticle is selected from the group consisting of: TiO2, SiO2, Yttria-stabilized zirconia (YSZ), Al2O3, MoO3, CrO3, CeO2 and mixtures thereof.

51. The assembly as recited in claim 49 wherein the second metallic substrate is a steel substrate or an aluminum substrate.

52. The assembly as recited in claim 49 wherein the second metallic substrate includes a second steel substrate; and a second pre-coating coating the second steel substrate and including at least one titanate and at least one nanoparticle, the second steel substrate when bare having a reflectance higher or equal to 60% at all wavelengths between 6.0 and 15.0 μm.

53. A method for manufacture of automotive or shipbuilding parts comprising employing the assembly as recited in claim 49.
